(19) United States
(12) Patent Application Publication
(10) Pub. No.: US 2017/0134361 A1
(43) Pub. Date: May 11, 2017

(54) METHODS AND SYSTEMS FOR PRINTING MESSAGES

(71) Applicant: PISMO LABS TECHNOLOGY LIMITED, Hong Kong (CN)

(72) Inventors: Yu Yeung, Hong Kong (HK); Kang Yin Su, Hong Kong (HK)

(73) Assignee: PISMO LABS TECHNOLOGY LIMITED, Hong kong (HK)

(21) Appl. No.: 14/905,825

(22) PCT Filed: May 28, 2015
(86) PCT No.: PCT/IB2015/054009

§ 371 Date: Jan. 18, 2016

(51) Int. Cl. H04L 29/06; H04N 1/00; H04N 1/32; G06K 15/02

(52) U.S. Cl. CPC H04L 63/083; H04L 63/0846; G06K 15/024; H04N 1/00344; H04N 1/32133; H04N 2201/3269; H04N 2201/3205; H04L 67/10

(57) ABSTRACT

The present invention discloses methods and systems for printing messages on a print medium. The system comprises a server, a print server, and a gateway. The print server receives a list of server messages from a remote server and also receives a user input from a user. Based on the user input, the print server determines whether a printing message should be printed on the print medium. The printing message is determined from the list of server messages. The gateway also receives a first password list from the remote server and an input password from a user. If the input password matches one of the passwords in a verification password list, the gateway allows the user to access a network.

### TECHNICAL FIELD

The present invention relates in general to the field of computer networks. More particularly, the present invention relates to methods and systems for printing messages on a print medium and authenticating users to access a network.

### BACKGROUND ART

In recent times, public transportation systems, such as trains and buses, may provide internet access to passengers. In general, the internet access is provided using wireless networks, such as Wi-Fi or any other wireless local area network (WLAN). The internet services may be used by anyone through their electronic devices if they are within the coverage area of the WLAN. It may not be desirable to provide Internet access to everyone within the coverage area, and should only be limited only to passengers of the vehicles. Alternatively, the WLAN may be password protected, and can only be accessed by users who have a valid password. It may be troublesome to manually provide each and every passenger with a password for accessing the Internet. For security purposes, the password for accessing the Internet through the WLAN may be required to change frequently. A solution is required to allow only selected passengers to access the Internet through the WLAN with a valid password.

### DISCLOSURE OF INVENTION

### Summary of Invention

The present invention discloses methods and systems for printing messages on a print medium. The system comprises a server, a print server, and a gateway. The print server receives a list of server messages from a remote server and also receives a user input from a user. Based on the user input, the print server determines whether a printing message should be printed on the print medium. The print server uses a printer to print messages on the print medium if it is determined that a printing message should be printed. The printing message is determined from the list of server messages.

According to one of the embodiments of the present invention, the printing message is a password, an advertisement, or a QR code used for authenticating the user for accessing a network.

According to one of the embodiments, the list of server messages may be a list of passwords. The print server may further receive a second list of passwords from the server.

According to one of the embodiments, the list of server messages comprise codes. The print server determines whether a printing message should be printed on the print medium based on a lookup of a database. The database comprises printing messages corresponding to the codes.

The present invention further discloses a gateway for authenticating a user with a password for accessing a network at the gateway. The password is printed by a printer on the print medium. The printer is connected to the print server. The gateway receives a first password list from the remote server and an input password from a user. The first password list is then used as a verification password list. If the input password matches one of the passwords in the verification password list, the gateway allows the user to access a network.

According to one of the embodiments, when the gateway further receives a second password list from the remote server, the first password list is expired. The gateway then stops using the first password list as the verification password list and starts using the second password list as the verification password list. According to one of the embodiments, if an input password that is input by a user matches one of the passwords in the first password list, but does not match one of the password in the verification password list, the gateway allows the user to access the network with restrictions. According to one of the embodiments, the first password list and second password list may comprise hashed values of passwords.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Embodiments, or portions thereof, may be embodied in program instructions operable upon a processing unit for performing functions and operations as described herein. The program instructions making up the various embodiments may be stored in a storage medium.

The program instructions making up the various embodiments may be stored in a storage medium. Moreover, as disclosed herein, the term “storage medium” may represent one or more devices for storing data, including read only memory (ROM), programmable read-only memory (PROM), erasable programmable read-only memory (EPROM), random access memory (RAM), magnetic RAM, core memory, floppy disk, flexible disk, hard disk, magnetic tape, CD-ROM, flash memory devices, a memory card and/or other machine readable mediums for storing information. The term “machine-readable medium” includes, but is not limited to portable or fixed storage devices, optical storage mediums, magnetic mediums, memory chips or cartridges, wireless channels and various other mediums capable of storing, containing or carrying instruction(s) and/or data. A machine-readable medium can be realized by virtualization, and can be a virtual machine readable medium including a virtual machine readable medium in a cloud-based instance.

The term computer-readable medium, main memory, or secondary storage, as used herein refers to any medium that participates in providing instructions to a processing unit for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics. Transmission media can also take the form of acoustic or light waves, such as those generated during radio-wave and infra-red data communications.

A volatile storage may be used for storing temporary variables or other intermediate information during execution of instructions by a processing unit. A non-volatile storage or static storage may be used for storing static information and instructions for processor, as well as various system configuration parameters.

The storage medium may include a number of software modules that may be implemented as software code to be executed by the processing unit using any suitable computer instruction type. The software code may be stored as a series of instructions or commands, or as a program in the storage medium.

Various forms of computer readable media may be involved in carrying one or more sequences of one or more instructions to the processor for execution. For example, the instructions may initially be carried on a magnetic disk from a remote computer. Alternatively, a remote computer can load the instructions into its dynamic memory and send the instructions to the system that runs the one or more sequences of one or more instructions.

A processing unit may be a microprocessor, a microcontroller, a digital signal processor (DSP), any combination of those devices, or any other circuitry configured to process information.

A processing unit executes program instructions or code segments for implementing embodiments of the present invention. Furthermore, embodiments may be implemented by hardware, software, firmware, middleware, microcode, hardware description languages, or any combination thereof. When implemented in software, firmware, middleware or microcode, the program instructions to perform the necessary tasks may be stored in a computer readable storage medium. A processing unit(s) can be realized by virtualization, and can be a virtual processing unit(s) including a virtual processing unit in a cloud-based instance.

Embodiments of the present invention are related to the use of a computer system for implementing the techniques described herein. In an embodiment, the inventive processing units may reside on a machine such as a computer platform. According to one embodiment of the invention, the techniques described herein are performed by computer system in response to the processing unit executing one or more sequences of one or more instructions contained in the volatile memory. Such instructions may be read into the volatile memory from another computer-readable medium. Execution of the sequences of instructions contained in the volatile memory causes the processing unit to perform the process steps described herein. In alternative embodiments, hard-wired circuitry may be used in place of or in combination with software instructions to implement the invention. Thus, embodiments of the invention are not limited to any specific combination of hardware circuitry and software.

A code segment, such as program instructions, may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Alternatively, hardwired circuitry may be used in place of, or in combination with, software instructions to implement processes consistent with the principles of the invention. Thus, implementations consistent with principles of the invention are not limited to any specific combination of hardware circuitry and software.

A network interface that may be provided by a node is an Ethernet interface, a frame relay interface, a fibre optic interface, a cable interface, a DSL interface, a token ring interface, a serial bus interface, a universal serial bus (USB) interface, Firewire interface, Peripheral Component Interconnect (PCI) interface, etc.

A network interface may be implemented by a standalone electronic component or may be integrated with other electronic components. A network interface may have no network connection or at least one network connection depending on the configuration. A network interface may be an Ethernet interface, a frame relay interface, a fibre optic interface, a cable interface, a Digital Subscriber Line (DSL) interface, a token ring interface, a serial bus interface, a universal serial bus (USB) interface, Firewire interface, Peripheral Component Interconnect (PCI) interface, cellular network interface, etc.

A network interface may connect to a wired or wireless access network. An access network may carry one or more network protocol data. A wired access network may be implemented using Ethernet, fiber optic, cable, DSL, frame relay, token ring, serial bus, USB, Firewire, PCI, or any material that can pass information. An wireless access network may be implemented using infra-red, High-Speed Packet Access (HSPA), HSPA+, Long Term Evolution (LTE), WiMax, General packet radio service (GPRS), Global System for Mobile Communications (GSM), Enhanced Data rates for GSM Evolution (EDGE), Code division multiple access (CDMA), WiFi, CDMA2000, Wideband CDMA (WCDMA), Time Division CDMA (TD-SCDMA), BLUETOOTH, WiBRO, Evolution-Data Optimized (EV-DO); Digital Enhanced Cordless Telecommunications (DECT); Digital AMPS (IS-136/TDMA); Integrated Digital Enhanced (iDEN) or any other wireless technologies. For example, a network interface may be used as a local area network (LAN) interface or a wide area network (WAN) interface.

Embodiments, or portions thereof, may be embodied in a computer data signal, which may be in any suitable form for communication over a transmission medium such that it is readable for execution by a functional device (e.g., processing unit) for performing the operations described herein. The computer data signal may include any binary digital electronic signal that can propagate over a transmission medium such as electronic network channels, optical fibers, air, electromagnetic media, radio frequency (RF) links, and the like, and thus the data signal may be in the form of an electrical signal, optical signal, radio frequency or other wireless communication signal, etc. The code segments may, in certain embodiments, be downloaded via computer networks such as the Internet, an intranet, local area network (LAN), metropolitan area network (MAN), wide area network (WAN), the PSTN, a satellite communication system, a cable transmission system, and/or the like.

FIG. 1 illustrates an exemplary network environment according to various embodiments of the present invention. Server 101 connects to the interconnected networks 104 through its one or more network interfaces. Gateway 102 is connected to a wireless network, such as cellular network 103, and is capable of connecting to the interconnected networks 104 through cellular network 103. Print server 105 is connected to interconnected networks 104. For example, print server 105 may be connected to a printing device 106 for printing printer messages on a print medium such as a piece of paper, an article, a piece of plastic, a ticket, etc. Print server 105 may control printing device 106 to print specific printing messages on the print medium. The print server and the printing device may be the same apparatus or enclosed in one apparatus.

Printing messages to be printed are directly or indirectly based on server messages generated by server 101. When the printing messages are directly based on server messages generated by server 101, i.e. the printing messages are same as the server messages, the printing messages can then be printed by print server 105 without modification of the server messages. When the printing messages are indirectly based on server messages generated by server 101, the printing messages can then be printed by print server 105 on a print medium, such as a ticket, by retrieving the printing messages based on the server messages. Server 101 sends the server message to print server 105. In one variant, printing device 106 and print server 105 can be replaced by one apparatus that is capable of communicating with server 101 and print printing messages on a print medium. Server 101 also sends a gateway message to gateway 102. Gateway message corresponds to the printing message. Gateway message could be the same as the printing message or different from the printing message. For example, the gateway message and printing message are the same password. In another example, the gateway message and printing message are the same advertisement messages. In another example, the printing message is a password and the gateway message is a hashed value of the password.

Electronic devices 107 such as smart-phones, laptops, tablets, etc may connect to interconnected networks 104 through gateway 102. For example, gateway 102 is an IEEE 802.11 access point and capable of providing wireless connection service to electronic devices 107. The number of gateways 102 connected to interconnected networks 104 is not limited to one. For example, there could a plurality of gateways 102 deployed in different sections of a train. Therefore, passengers may use their smart-phones or laptops to access to interconnected networks 104 such as the Internet through gateway 102.

In order to determine whether electronic devices 107 are allowed to use gateway 102 to access interconnected networks 104. Users of electronic devices 107 are required to enter authentication information, such as password and scanning a QR code, printed on the print ticket by printing device 106 in a user interface generated by gateway 102. The authentication information is the printing message or corresponding to the printing message.

In one of the embodiments, gateway 102 may receive gateway messages from server 101. The gateway messages may be used by gateway 102 for authorization purpose. For example, the gateway messages may be passwords for passengers for accessing the WiFi service in the train.

FIG. 2 is a flowchart illustrating a process according to one of the embodiments of the present invention. A user chooses a ticket type in step 201. The user may be a passenger buying a train ticket. The ticket type may be the ticket class of a train ticket. The passenger may choose a train ticket through a user interface of print server 105. Print server 105 can be a ticket machine. The passenger may choose a ticket type through a user interface of print server 105. The passenger may then confirm his choice in the user interface before purchasing tickets. Those who are skilled in the art would appreciate that the user interface may be a web user interface, a LCD display, an audio user interface, a video user interface, etc. For better illustration, the train tickets are illustrated in FIG. 5.

Train tickets 501 and 502 are train tickets from London to Leeds. Train ticket 501 is a standard class ticket and train ticket 502 is a premium class ticket. It should be understood that additional services may be available to passengers who purchase the premium class train ticket. The additional services may include WiFi service. For example, password 503 printed on train ticket 502 may be used for authorization against gateway 102. It should be noted that password 503 can be in form of characters, words, digits, barcode, QR code, etc.

FIG. 2 is viewed in conjunction with FIG. 5 for better understanding of the embodiment. For illustration purposes, the passenger chooses a train ticket 502 in step 201. According to the ticket type, processing unit 801 of print server 105 determines whether there is a printing message to be printed on train ticket 502 in step 202. Since the ticket class of train ticket 502 is premium, there is a printing message to be printed on train ticket 502. Then print server 105 retrieves the printing message in step 203. The message may be retrieved from a storage medium of print server 105 or may be retrieved from a remote server or database that is accessible by print server 105 such as server 101. For illustration purposes, the printing message is password 503. Train ticket 502 is then printed by print device 106 in step 204 with password 503 printed on it. Finally, train ticket 502 is then delivered to the user in step 206.

On the other hand, the user may choose a ticket type in which no printing message is to be printed on the ticket. For example, a passenger chooses a standard class train ticket in step 201. Since no WiFi service is available for standard class passenger, no password will be printed on the ticket. Then processing unit 801 of print server 105 may instruct print device 106 to print train ticket 501 without a printing message for authenticating against gateway 102 in step 205.

FIG. 6 illustrates a login page for WiFi service according to one of the embodiments of the present invention. When a passenger wants to access the Internet in a train, the login page may be shown in their web browser. Login page 601 includes text box 602, checkbox 603 and button 604. In order to login, the passenger enters the password printed on the train ticket, such as train ticket 502, in text box 602 and agrees the terms of service and acceptable use policy by clicking checkbox 603. If the input password is correct, the passenger may be allowed to access the Internet. In one variant, instead of entering a password, the passenger may take a photo of the barcode or QR code printed on the train ticket when authenticating with gateway 102.

According to one of the embodiments of the present invention, print server 105 may receive an input. For illustration purposes, an input may be received from a passenger who chooses a premium class train ticket through a user interface of print server 105. The user interface of print server 105 may be, but is not limited to, a button, a LCD display, an audio user interface, a video user interface, etc. The passenger may be given a password for WiFi service in the train. The password may vary every month, every week, every day, and every hour, for different train and/or for different passenger. The password for January may be different from the password for February. The list of passwords may be stored locally in print server 105. In order to reduce network overhead and improve responsiveness, the passwords may be retrieved to the print server 105 before the passenger has selected the ticket class. Alternatively, the password may be retrieved after the passenger has selected the ticket class and before the ticket is being printed.

Print server 105 retrieves the printing message based on the input. For example, after the passenger has chosen a premium class train ticket such as train ticket 502, print server 105 may retrieve password 503 based on the ticket class and the current month. The password may be retrieved from storage medium of print server 105 or may be retrieved from a remote server/database that is accessible by print server 105.

FIG. 3 is a flowchart illustrating a process according to one of the embodiments of the present invention. Server 101 generates a list of server messages in step 301. For example, a list of server messages may be a list of passwords. For illustration purposes, the list of passwords may consist of twelve passwords that each corresponds to one month. After server 101 has generated the list of server messages in step 301, server 101 sends the list of server messages to the print server such as printer server 105 in step 302. If there is a printing message to be printed on the ticket, print server 105 retrieves a password from its storage medium and prints the printing message on the ticket through printing device 106. The printing messages may or may not be the same as server messages. However, the printing messages are based on the server messages. Server 101 also sends the list of gateway messages to gateway 102 in step 303. For illustration purposes, the list of gateway messages may be a list of passwords. Gateway 102 may be an IEEE 802.11 access point. After a passenger input a password for using the wireless service in a train, gateway 102 authenticates the user by verifying the input password with the list of gateway messages received from server 101. If the password is correct, the passenger is then authorized to use the WiFi service in the train. It should be noted that the password may be, but not limited to, characters, words, digits, QR code, etc. Those who are skilled in the art would appreciate that the number of passwords in the list of passwords is not limited to twelve.

According to one of the embodiments, the printer messages and server messages are not the same. When print server 105 receives server messages from server 101, Print server 105 retrieves printer messages corresponding to server messages from a database. In one variant, the database is stored locally in a storage medium of print server 105. Alternatively, the database is stored remotely and is accessible by print server 105 through a wired or wireless connection. For example, a password needs to be printed on a print medium. Server 101 can send a list of server messages to print server 105, where the server messages are codes corresponding to passwords. Print server 105 may then retrieve a list of printer messages based on the list of server messages. Print server 105 determines passwords corresponding to the codes in the list of server messages by looking up the database. Print server 105 then prints the corresponding password on a print medium. In one example, the code can be a hashed value of the password, and print server 105 is capable of retrieving the password from the code.

It should be understood that the messages, i.e. server messages and printer messages, are not limited to passwords and the format of messages is not limited to characters or words. For illustration purposes, a message can be an advertisement printed on a ticket. The advertisements may comprises figures, QR code, patterns, etc. Also, the advertisements may be used for promotion purposes instead of authorization purposes.

Those who are skilled in the art would appreciate that the print medium is not limited to a train ticket. For illustration purposes, the print medium can be a discount coupon and the message can be a barcode. If a customer spends more than certain amount of money in a department store, the customer may be given a discount coupon. The printing message printed on the discount coupon may be a barcode representing the amount of discount. In one variant, the message may be unique to the customer. In one variant, the message may be printed according to the amount of money spent, the date, the location of the customer, the location of the print server, etc.

FIG. 4 is a flowchart illustrating a process according to one of the embodiments of the present invention. Server 101 receives a reset request in step 401. In step 402, processing unit 701 of server 101 generates a second list of server messages. For illustration purposes, the list of server messages may be a list of passwords. There are myriad reasons to reset a list of passwords. For example, the prior list of passwords may be expired. Also, some of the passwords in the prior list of passwords may not function properly in gateway 102. Then server 101 may choose to generate a second list of passwords replacing the prior list of passwords. Besides, there may be information leakage in which the passwords may be disclosed to the public. Then server 101 may need to generate a second list of passwords and discard the prior list of passwords. Processing unit 701 of server 101 generates a second list of passwords in step 402 after a reset request is received. Then server 101 sends the second list of passwords to the print server such as print server 105 in step 403. Processing unit 701 of server 101 also instructs the print server to discard the prior list of passwords in step 403. Similarly, server 101 also sends the second list of gateway messages to gateway 102 and also instruct the network node to discard the prior list of gateway messages in step 404. The second list of gateway messages may also be same as the second list of passwords.

In another example, the list of messages may be a list of advertisements. The advertisements may be changed at a regular time basis such as every day, every week, every month, etc. For example, the advertisements may be changed daily. Then server 101 may receive a reset request daily in step 401 and may generate a second list of advertisements daily in step 402. The second list of advertisements may sent to print server 105 and gateway 102 from server 101. Furthermore, server 101 may instruct print server 105 and gateway 102 to discard the prior list of advertisements. Therefore, the advertisements printed on a ticket will be different every day.

FIG. 9A is a flowchart illustrating a process according to one of the embodiments of the present invention. Gateway 102 receives a password in step 901. For illustration purposes, a WiFi service is available for premium class passenger in a train. Gateway 102 may be an IEEE 802.11 access point in the train. A password is given to a premium class passenger for accessing the network through gateway 102. Gateway 102 may receive a password through a web user interface such as login page 601. In step 902, gateway 102 determines whether the password is valid. Gateway 102 may match the input password with a verification password list. A verification password list is used by gateway 102 to validate the input password. The verification password list may be retrieved from a storage medium of gateway 102 or may be retrieved from a remote server/database that is accessible by gateway 102 such as server 101. In one variant, the verification password list can be expired. For example, the verification password list may be expired within one day. Gateway 102 may receive a second password list from server 101 daily and use the second password list as the verification password list. If the input password matches one of the passwords in the verification password list, gateway 102 may allow the user to access network such as the Internet through gateway 102 in step 903. If the input password is not found in the verification password list, gateway 102 may not allow the user to access network such as the Internet through gateway 102 in step 904.

FIG. 9B is a flowchart illustrating a process according to one of the embodiments of the present invention. Gateway 102 receives a password in step 901 and determines whether the password is valid in step 902. If the password is determined to be invalid in step 902, gateway 102 may determine whether the password match any of expired passwords in step 921. The expired password list may be retrieved from storage medium of gateway 102. If the password matches one of the passwords in expired password list, gateway 102 may inform the user that the password is expired in step 922. Otherwise, gateway 102 may not allow the user to access network in step 904. For example, a user inputs a password which has expired one day ago and the password matches one of the passwords in the expired password list. Gateway 102 may inform the user through a web user interface in step 922. For example, an error message may be displayed in login page 601 informing the user regarding the password is expired. After the user is informed the expiry of password, gateway 102 may allow the user access the network with restrictions in step 923. The restrictions can be restrictions of time, restrictions of websites, etc. For example, for advertising purposes, gateway 102 may allow the user to access some websites only. In another example, the user may be allowed to access the network through gateway 102 within a time limit such as fifteen minutes. After the time limit is reached, a web page may be displayed inviting the user to purchase any service for accessing the network. If no service is chosen, the user may not allow to access the network through gateway 102. In another example, the user may be allowed to access the network with limited bandwidth and is not capable of utilizing the full bandwidth. For illustration purpose, users with a valid password are capable of accessing the network with a bandwidth of 1 Mbps. However, users that input an expired password are capable of accessing the network with a bandwidth of 512 Kbps.

In an alternative embodiment, gateway 102 allows the user to have full access to the network even if the user enters a password that matches one of the passwords in the expired password list.

FIG. 7 illustrates a block diagram of a server according to various embodiments of the present invention.

Server 101 can be a network node or network host that provides network functionalities or have networking capabilities respectively. For example, server 101 can be a router, a hub, a gateway, an IEEE 802.11 access point, a database server, a web server, a virtualized router, a laptop, a computer, a smart-phone, a tablet and etc. Server 101 comprises processing unit 701, main memory 702, system bus 703, secondary storage 704 and network interface 705. Processing unit 701 and main memory 702 are connected to each other directly. System bus 703 connects processing unit 701 directly or indirectly to secondary storage 704 and network interface 705. Using system bus 703 allows server 101 to have increased modularity. System bus 703 can be any of several types of bus structures including a memory bus, a peripheral bus, and a local bus using any of a variety of bus architectures. Secondary storage 704 stores program instructions for execution by processing unit 701. There is no limitation as to how many network interface 705 server 101 can have, such that server 101 may have one or a plurality of network interfaces through which it may connect to one or a plurality of networks.

FIG. 8 illustrates a block diagram of a print server according to various embodiments of the present invention. Print server 105 comprises processing unit 801, main memory 802, system bus 803, secondary storage 804, network interface 805, user input 806 and printer interface 807. System bus 803 connects processing unit 801 directly or indirectly to user input 806 and printer interface 807. Using system bus 803 allows print server 105 to have increased modularity. User input 806 may be connected to a sensor, a keyboard, a touch-screen display, a button, a microphone, a video camera, a fingerprint scanner, or any other components that can be used to receive an input or information. Printer interface 807 may be a connector found on print server 105 intended for connecting a printer such as printing device 106. Printer interface 807 can be implemented by standalone electronic component or may be integrated with other electronic components. Printer interface 807 may be network interface, a universal serial bus (USB) interface, parallel port interface, serial bus interface, etc. In one variant, printer interface 807 may be an embedded printer. Therefore, print server 105 may have printing functionalities without connecting to printing device 106.

FIG. 10 illustrates a block diagram of a gateway according to various embodiments of the present invention. Gateway 102 comprises processing unit 1001, main memory 1002, system bus 1003, secondary storage 1004, network interface 1005 and cellular modem 1006. Processing unit 1001 and main memory 1002 are connected each other directly. System bus 1003 connects processing unit 1001 directly or indirectly to network interface 1005 and cellular modem 1006.

Gateway 102 has access to at least one cellular modem for connecting a cellular communications network such as cellular network 1006. The cellular modem can be implemented using an embedded cellular modem, as internal cellular modem or an external cellular modem. For example, the cellular modem can be Universal Serial Bus (USB) based cellular modem. In one variant, the cellular modem is connected to a network interface, such as network interface 1005, and hence gateway 102 has access to the cellular modem through network interface 1005. In one variant, the cellular modem is connected to gateway 102 through a private or public interconnected network such that gateway 102 can receive messages through the cellular modem.

The embodiments were chosen and described in order to best explain the principles of the invention and its practical applications, to thereby enable others skilled in the art to best utilize the invention and various embodiments with various modifications as are suited to the particular use contemplated.

### BRIEF DESCRIPTION OF DRAWINGS

FIG. 1 illustrates an exemplary network environment according to various embodiments of the present invention.

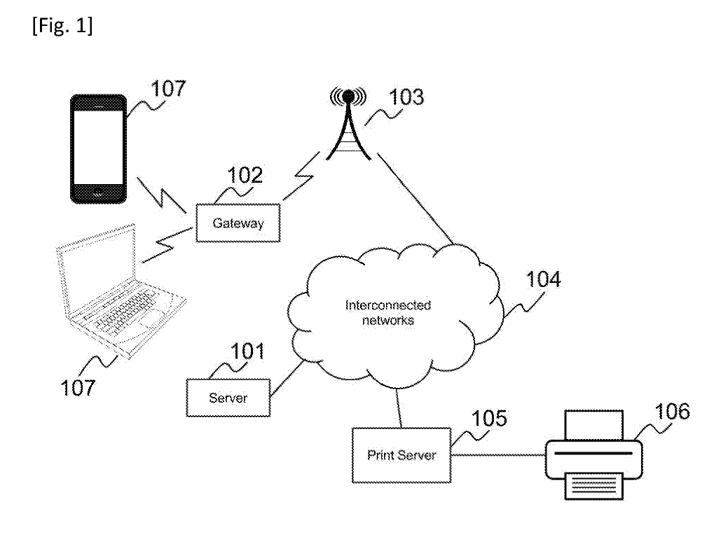

FIG. 2 is a flowchart illustrating a process showing how a ticket is generated according to one of the embodiments.

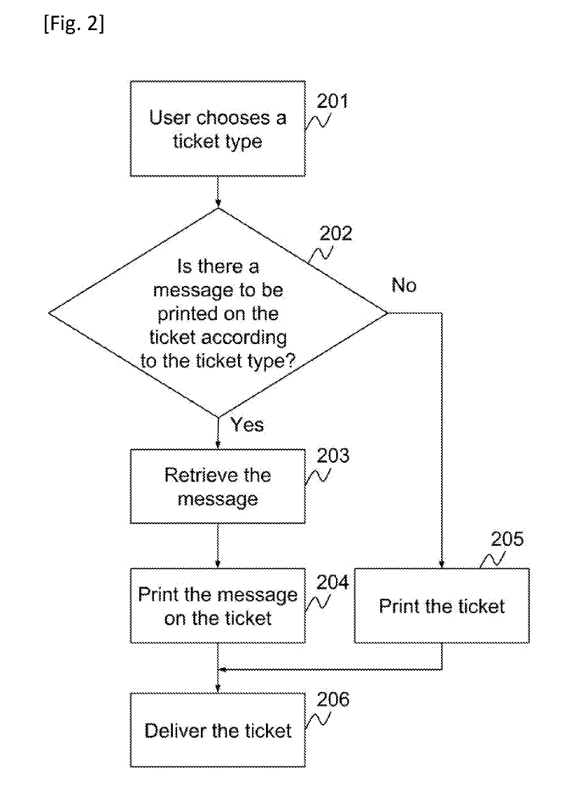

FIG. 3 is a flowchart illustrating a process according to one of the embodiments.

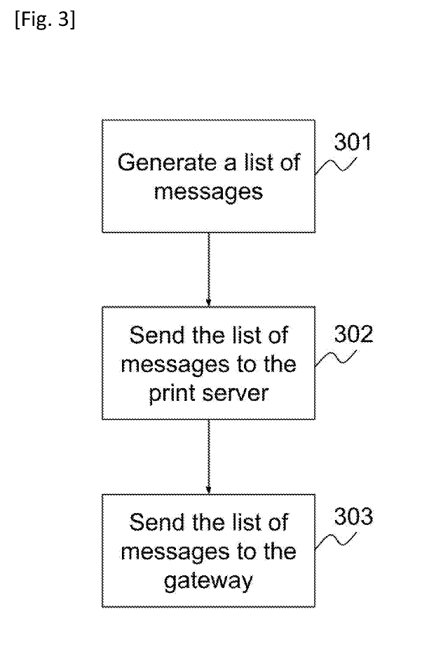

FIG. 4 is a flowchart illustrating a process showing how to reset a list of message according to one of the embodiments.

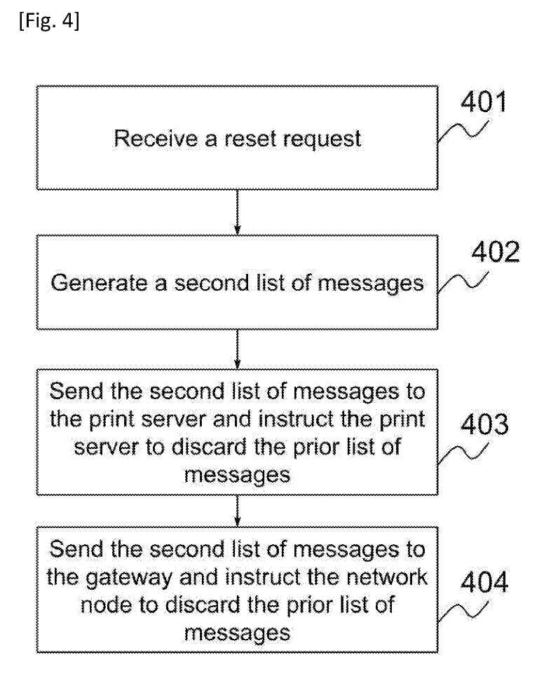

FIG. 5 illustrates two train tickets according to one of the embodiments.

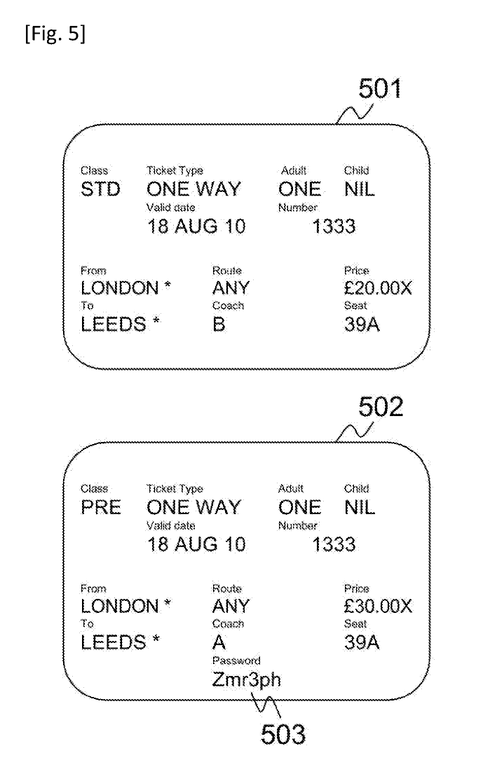

FIG. 6 is an illustrative login page according to one of the embodiments.

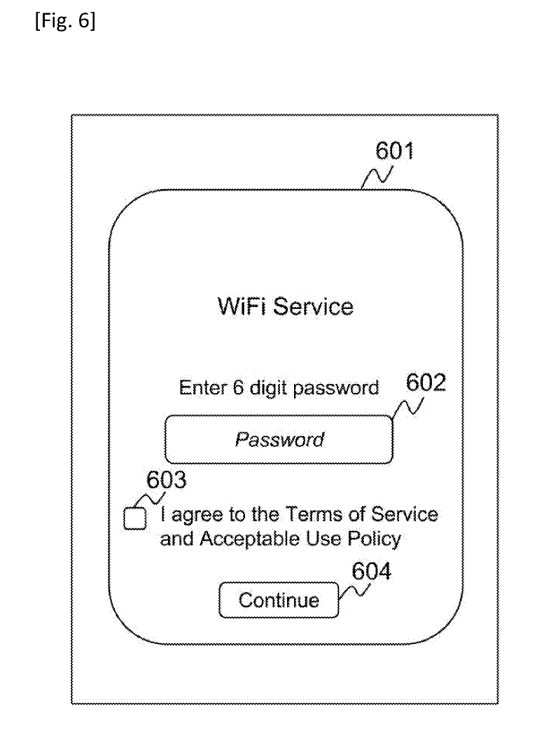

FIG. 7 is an illustrative block diagram of a server according to one of the embodiments.

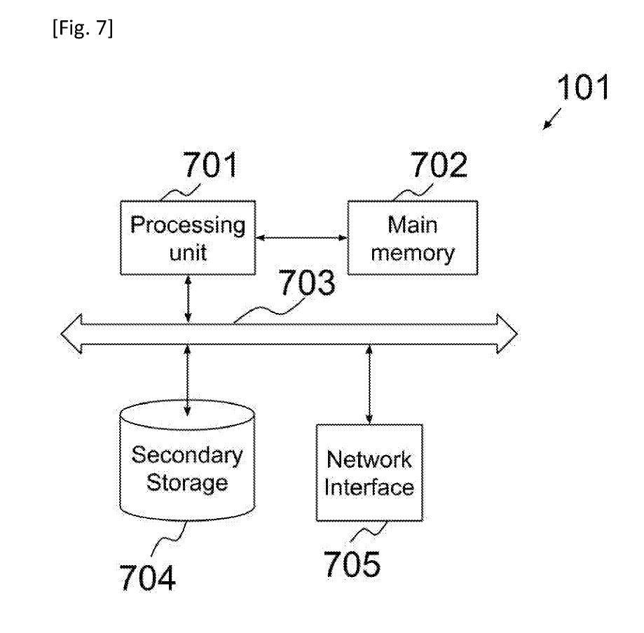

FIG. 9 is an illustrative block diagram of a print server according to one of the embodiments.

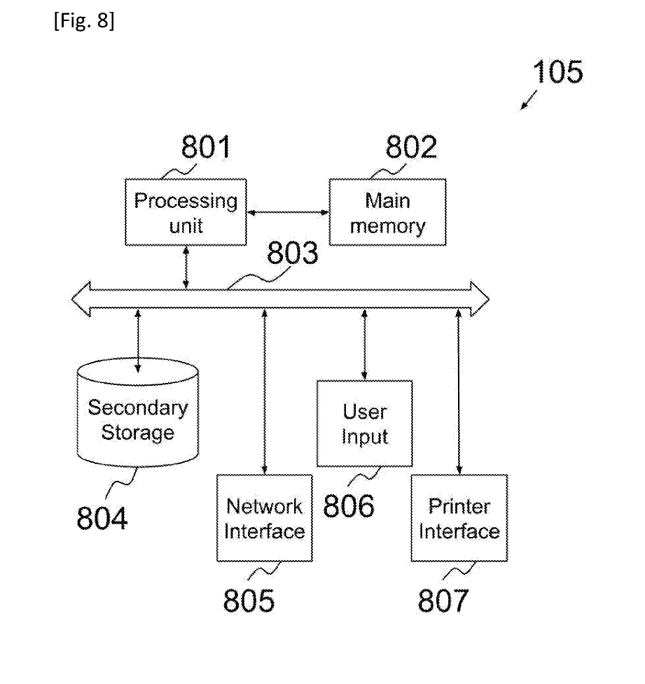

FIG. 9A is a flowchart illustrating a process in which a user may not allowed to access the network according to one of the embodiments.

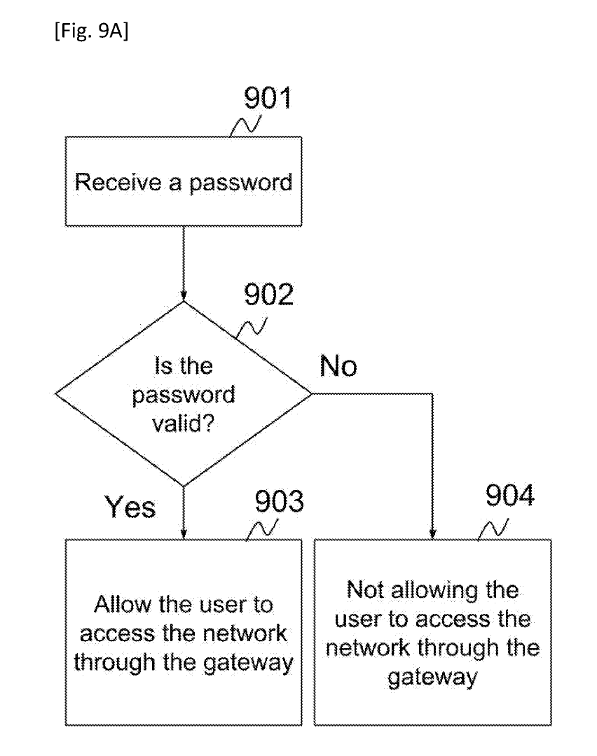

FIG. 9B is a flowchart illustrating a process in which a user may allowed to access the network with restrictions according to one of the embodiments.

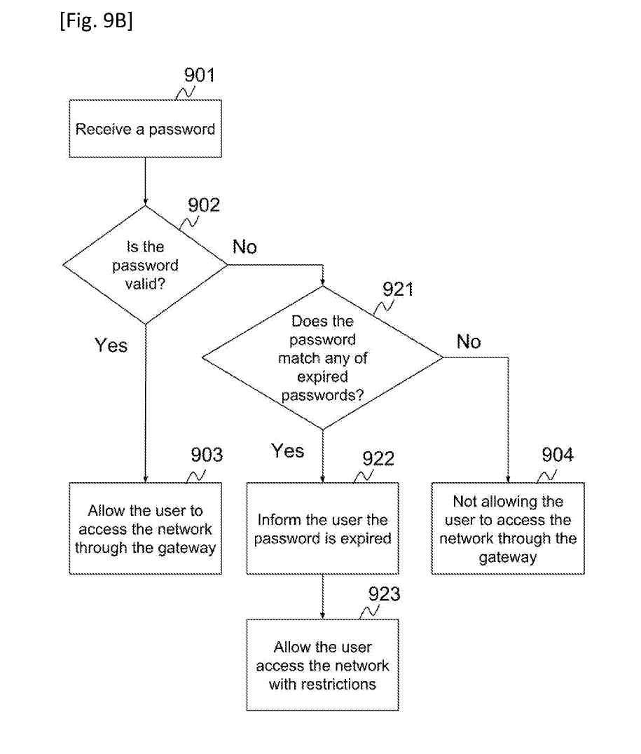

FIG. 10 is an illustrative block diagram of a gateway according to one of the embodiments.

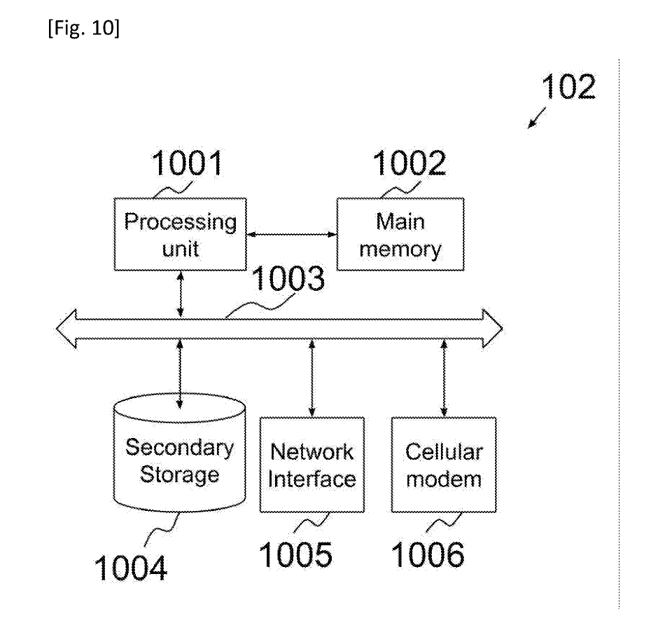

1. A method performed at a print server for printing messages on a printing medium, comprising the steps of:
(a) receiving a list of server messages from a remote server;
(b) receiving a user input from a user;
(c) determining whether a printing message is required to be printed on the printing medium;
(d) if a printing message is required to be printed on the printing medium, printing the printing message on the printing medium;
(e) if a printing message is not required to be printed on the printing medium, not printing the printing message on the printing medium; and
wherein the printing message is determined from the list of server messages.

2. The method of claim 1, wherein the printing message is a first password.

3. The method of claim 1, wherein the printing message is a QR code used for authenticating the user for accessing a network.

4. The method of claim 2, further comprising receiving a second list of passwords from the server.

5. The method of claim 1, wherein the printing message is an advertisement.

6. The method of claim 1, wherein the list of server messages comprise codes, wherein the determining of step (c) is substantially based on a lookup of a database, and wherein the database comprises printing messages corresponding to codes.

7. A method carried out at a gateway for authenticating a user with a password for accessing a network at a gateway, wherein the password is printed by a printer on a print medium and wherein the printer is connected to a print server, comprising the steps of:
(a) receiving a first password list from a remote server;
(b) retrieving an input password from a user;
(c) determining whether the input password matches one of passwords in a verification password list, wherein the first password list is used as the verification password list; and
(d) allowing the user to access the network if the input password matches one of passwords in the verification password list; and
(e) not allowing the user to access the network if the input password does not match one of passwords in the verification password list.

8. The method of claim 7, further comprising:
(f) receiving a second password list from the remote server;
(g) expiring the first password list;
(h) stopping to use the first password list as the verification password list; and
(i) using the second password list as the verification password list.

9. The method of claim 8, further comprising allowing the user to access the network with restrictions if the input password matches one of the passwords in the first password list and does not match one of the passwords in the verification password list.

10. The method of claim 8, wherein the first password list and the second password list comprise hashed values of passwords.

11. A system comprising:
a remote server for sending a list of server messages to a print server and sending a list of gateway messages to a gateway;
the print server comprising:
at least one printer interface;
at least one user input;
at least one first network interface;
at least one first processing unit;
at least one first storage medium storing program instructions executable by the at least one first processing unit for printing messages on a printing medium, comprising the steps of:
(a) receiving a list of server messages from a remote server;
(b) receiving a user input from a user;
(c) determining whether a printing message is required to be printed on the printing medium;
(d) if a printing message is required to be printed on the printing medium, printing the printing message on the printing medium;
(e) if a printing message is not required to be printed on the printing medium, not printing the printing message on the printing medium; and
wherein the printing message is determined to from the list of server messages;
a gateway comprising:
at least one cellular modem;
at least one second network interface;
at least one second processing unit;
at least one second storage medium storing program instructions executable by the at least one second processing unit for authenticating a user with a password for accessing a network at a gateway, wherein the password is printed by a printer on a print medium and wherein the printer is connected to a print server, comprising the steps of:
(f) receiving a first password list from a remote server;
(g) retrieving an input password from a user;
(h) determining whether the input password matches one of passwords in a verification password list, wherein the first password list is used as the verification password list;
(i) allowing the user to access the network if the input password matches one of passwords in the verification password list; and
(j) not allowing the user to access the network if the input password does not matches one of passwords in the verification password list.

12. The system of claim 11, wherein the printing message is a first password.

13. The system of claim 11, wherein the printing message is a QR code used for authenticating the user for accessing a network.

14. The system of claim 12, wherein the at least one first storage medium further stores program instructions executable by the at least one first processing unit for receiving a second list of passwords from the server.

15. The system of claim 11, wherein the printing message is an advertisement.

16. The system of claim 11, wherein the list of server messages comprise codes, wherein the determining of step (c) is substantially based on a lookup of a database, and wherein the database comprises printing messages corresponding to codes.

17. The method of claim 11, wherein the at least one second storage medium further stores program instructions executable by the at least one second processing unit for:
(f) receiving a second password list from a remote server;
(g) expiring the first password list;
(h) stopping to use the first password list as the verification password list; and
(i) using the second password list as the verification password list.

18. The method of claim 17, wherein the at least one second storage medium further stores program instructions executable by the at least one second processing unit for allowing the user to access the network with restrictions if the input password matches one of the passwords in the first password list and does not match one of the passwords in the verification password list.

19. The method of claim 17, wherein the first password list and the second password list comprise hashed values of passwords.
